(19) United States
(12) Patent Application Publication
(10) Pub. No.: US 2026/0056299 A1
(43) Pub. Date: Feb. 26, 2026

(54) METHOD FOR PROVIDING AN OUTPUT DISTANCE IMAGE OF A TIME-OF-FLIGHT SENSOR, TIME-OF-FLIGHT SENSOR AND COMPUTER PROGRAM PRODUCT

(71) Applicant: SICK AG, Waldkirch (DE)

(72) Inventor: Jennifer ERDMANN, Witzhave (DE)

(21) Appl. No.: 19/233,935

(22) Filed: Jun. 10, 2025

(30) Foreign Application Priority Data
Jun. 11, 2024 (EP) 24181380.7

(51) Int. Cl. G01S 7/4865; G01S 7/487; G01S 17/10; G01S 17/89

(52) U.S. Cl. CPC G01S 7/4865; G01S 7/4873; G01S 7/4876; G01S 17/10; G01S 17/89

(57) ABSTRACT

In one embodiment, a method for providing an output distance image of a time-of-flight sensor (10) has the following steps: supplying an individual image of a scene, wherein each data point of the individual image comprises a distance value, which is determined from at least one echo signal (S′) received by the time-of-flight sensor (10), an intensity and a noise floor strength; determining a first intermediate image by a temporal averaging of the at least one distance value of a plurality of data points, preferably of each data point, of the individual image or of a second intermediate image with a respective distance value of a corresponding data point of a settable number of preceding individual images using a first dynamic threshold that is at least dependent on the signal-to-noise ratio; and/or determining a second intermediate image by a spatial averaging of the at least one distance value of the plurality of data points, preferably of each data point, of the individual image or of at least one distance value of a plurality of data points, preferably of each data point, of the first intermediate image with at least one distance value of a settable number of neighboring data points of the individual image or of the first intermediate image using a second dynamic threshold that is at least dependent on the signal-to-noise ratio; and providing the first or the second intermediate image as the output distance image of the time-of-flight sensor.

The present invention relates to a method for providing an output distance image of a time-of-flight sensor, to a time-of-flight sensor, and to a computer program product.

Time-of-flight sensors are used to carry out distance measurements. Depending on the embodiment of the sensor, optical signals are, for example, used that are used for the measurement in so-called LiDAR sensors (light detection and ranging). Another possibility is the use of radio signals of a certain frequency and modulation that are used in a radar sensor. Both types of sensors determine the distance of an object in the environment of the sensor on the basis of the principle of time of flight measurement. For this purpose, such a sensor emits a pulsed transmission signal that is reflected at the object. The reflected pulses are detected in the form of an echo signal. Based on this echo signal, the sensor determines the time of flight of the pulses from the sensor to the object and back. The distance of the object is calculated as the product of the speed of light and half of the determined time of flight.

The present invention mainly relates to LiDAR sensors that perform distance measurements on the basis of light signals or light beams. However, the principle presented below can also be applied to radar sensors.

The accuracy of the distance values determined by a time-of-flight sensor depends on different influencing factors. Among other things, the distance accuracy of time-of-flight sensors is subject to statistical fluctuations. As a result, a time-of-flight sensor determines slightly different distance values even in an exactly identical scenario. In this respect, these statistical fluctuations are independent of systematic errors of a time-of-flight sensor, for example so-called walk errors. In order to counteract the statistical fluctuations in the distance accuracy of time-of-flight sensors, the measurement points are known to be averaged in time or in space. In this respect, the temporal averaging is based on a plurality of individual distance images, so-called frames, while neighboring pixels of the same individual image are used for the spatial averaging. Up to now, a fixed distance difference threshold, for example 30 centimeters or one meter, has in each case been used depending on the application. This threshold is usually selected as so large that data points are averaged even in a scenario with a very unfavorable signal-to-noise ratio (SNR). The threshold is thus designed such that an optimization for the worst-case scenario with a large statistical variance takes place. This fixed threshold is usually used for all the data points of an individual image. The choice of the threshold thus directly influences the result of the desired optimization.

When averaging picture elements, it should furthermore be noted that a temporal averaging leads to a delay, which can in particular be advantageous in fast-moving scenes. The delay in this respect increases as the number of individual images to be averaged increases. A spatial averaging, on the other hand, can lead to a distortion of the scene, in particular of non-planar objects or targets, for example of small corners or round surfaces. Such edges can be ground off by the spatial averaging. In other words, the spatial averaging can lead to a smoothing of the edges.

Accordingly, it is an object of the present invention to provide a method and a time-of-flight sensor that achieves an improvement in the distance accuracy, in particular the statistical distance accuracy, compared to the prior art.

The object is satisfied by the method for providing an output distance image according to claim 1 and by the time-of-flight sensor of claim 14. Further developments and embodiments are each the subjects of the dependent claims.

In one embodiment, a method for providing an output distance image of a time-of-flight sensor comprises the following steps:
supplying an individual image of a scene, wherein each data point of the individual image comprises a distance value, an intensity and a noise floor strength that were each determined from at least one echo signal received by the time-of-flight sensor;
determining a first intermediate image by a temporal averaging of the at least one distance value of a plurality of data points, preferably of each data point, of the individual image or of a second intermediate image with a respective distance value of a corresponding data point of a settable number of preceding individual images using a first dynamic threshold that is at least dependent on the signal-to-noise ratio; and/or
determining a second intermediate image by a spatial averaging of the at least one distance value of the plurality of data points, preferably of each data point, of the individual image or of at least one distance value of a plurality of data points, preferably of each data point, of the first intermediate image with at least one distance value of a settable number of neighboring data points of the individual image or of the first intermediate image using a second dynamic threshold that is at least dependent on the signal-to-noise ratio;
providing the first or the second intermediate image as the output distance image of the time-of-flight sensor.

The definitions given at the beginning also apply to the following statements unless otherwise described.

The output distance image is therefore a frame that is determined on the basis of a supplied individual image, likewise a frame, of a scene. Each data point of the individual image represents a pixel or a measurement angle as a fixed system, so-called solid state, or as a rotating system, depending on the design of the time-of-flight sensor. Each data point is assigned at least one distance value, an intensity and a noise floor strength that is a measure of the signal-to-noise ratio. They have each been determined from an echo signal received by the time-of-flight sensor. In some embodiments, the time-of-flight sensor receives more than one echo signal for a data point, whereby each data point of the individual image has further distance values, intensities and noise floor strengths according to the number of echo signals received for this purpose. In such a case, more than one distance value per data point can be used for the respective temporal or spatial averaging in order to determine the first and the second intermediate image.

To determine the first intermediate image, a temporal averaging of the distance values is now performed. A plurality of data points, preferably all the data points, of a frame are used for this purpose. For the temporal averaging, the respective distance value of a data point of the same position in a preceding individual image is used whose distance difference from the distance value of the data point under consideration, i.e. the data point to be averaged, is smaller than the first dynamic threshold.

The spatial averaging is carried out alternatively or additionally on the basis of the time-averaged frame, i.e. of the first intermediate image, or on the basis of the individual image. A plurality of or all the data points of the respective frame are used for this purpose. A settable number of neighboring, in particular directly neighboring, data points of the data point to be averaged is assumed. For example, the eight directly neighboring data points of a 3×3 pixel square are used. The number can also be set so that the 15 neighbors of a 4×4 pixel square in which the pixel under consideration is located are used. Typically, no more than 35 neighbors are used in a 6×6 pixel square. For the averaging, all those distance values of the neighbors are used whose distance difference from the distance value of the data point under consideration that is to be averaged is smaller than the first or the second dynamic threshold. The first and/or the second threshold can also be referred to as the distance difference threshold.

The output distance image of the time-of-flight sensor, which contains the first or the second intermediate image, has a higher distance accuracy compared to the prior art due to the use of the dynamic first and/or second threshold. Since the first and/or the second dynamic threshold is/are each signal-to-noise ratio-dependent, i.e. SNR-dependent, data points that have a greater distance difference from the distance value of the data point under consideration than is dynamically defined in the respective threshold are not considered in the averaging. The averaging is thus prevented from causing a deterioration because the values are too far apart. Due to the SNR dependency and thus echo intensity dependency and noise floor strength dependency of the first and/or second threshold, the averaging is adapted to the scene of the individual image and the distance accuracy of the output distance image is thus increased.

According to a further development, the first dynamic threshold for the data point is in each case determined in dependence on a statistical error, in particular a standard deviation, of the distance value of the data point of the individual image or of the second intermediate image and of the corresponding data points of the settable number of preceding individual images in relation to a respective difference of the distance values of the individual image or of the second intermediate image and of the corresponding data points of the settable number of preceding individual images. The statistical error, in particular the standard deviation, is in this respect related to the intensity and the noise floor strength of the data point.

The statistical error, for example the standard deviation here, is a measure of the scattering of the distance values of a data point around its expected value, i.e. the mean value. The first dynamic threshold is therefore determined, for example, in dependence on the standard deviation of the distance value of the data point of the individual image or of the second intermediate image and of the respective standard deviation of the corresponding data points of preceding individual images in relation to a respective difference of the distance values of the individual image or of the second intermediate image and of the respective corresponding data point of the preceding individual images. Thus, the first threshold is dynamically redefined for each data point.

According to a further development, for the temporal averaging, only distance values of the corresponding data point of preceding individual images are used whose difference from the distance value of the data point of the individual image or of the second intermediate image is smaller than a sum of the statistical errors of the distance value of the data point of the individual image or of the second intermediate image and of the corresponding data point of the preceding individual image of the settable number of preceding individual images. The sum can in particular be a weighted sum. The statistical error is in particular the standard deviation in each case.

When selecting the data points of the preceding individual images whose distance values are used for the temporal averaging of the currently considered data point of the individual image, the difference of the respective distance values is formed. Furthermore, a possibly weighted sum, for example, of the standard deviations of the distance values is formed according to the following formula:

$${k}_{t} * ( {σ}_{x} + {σ}_{j} ) \qquad ( 1 )$$

Here, kₜ denotes a weighting factor that is typically between one and three, σₓ denotes the standard deviation of the distance value of the data point of the preceding individual image, and σⱼ denotes the standard deviation of the distance value of the data point of the individual image or the second intermediate image that is currently under consideration and that is to be averaged.

In the case of the temporal averaging, in each case those distance values of the same pixel of the preceding individual images are therefore sorted out whose distance difference from the distance value of the same pixel of the current individual image is greater than the weighted sum of the associated standard deviations. Due to this use of the standard deviation of the distance of each data point, the time delay during the temporal averaging is minimized, in particular in regions with a medium to very good signal-to-noise ratio. Static parts of the scene of the individual image are largely averaged over time and thereby achieve an optimum precision, while rapidly changing parts of the scene are not averaged or are only averaged over a few frames, i.e. preceding individual images, since the distances quickly move out of the optimally and simultaneously minimally selected distance threshold. Compared to the fixed distance difference threshold known from the prior art, a significantly smaller distance difference threshold is therefore used for regions with a medium to good signal-to-noise ratio.

According to a further development, the statistical error, in particular the standard deviation, of the distance value of the data point of the individual image or of the second intermediate image is in each case selected from a first table that was determined by preceding measurements.

The first table is realized as a lookup table, for example. The first table that is, for example, realized as a 2D lookup table shows the statistical standard deviation of the distance value of a data point in relation to the noise floor strength and the intensity. For example, this 2D lookup table has the following appearance:

| Noise | | | | | | | | | |
|---|---|---|---|---|---|---|---|---|---|
| floor | Intensity | | | | | | | | |
| strength | 5 | 15 | 25 | 35 | 45 | 55 | 65 | 75 | 85 |
| 0 | 25 | 15 | 10 | 8 | 6 | 5 | 4 | 3 | 2 |
| 10 | — | 25 | 18 | 13 | 11 | 8 | 6 | 4 | 2 |
| 20 | — | — | 25 | 18 | 13 | 11 | 7 | 5 | 2 |
| 30 | — | — | — | 25 | 19 | 15 | 8 | 6 | 3 |
| 40 | — | — | — | — | 25 | 20 | 12 | 7 | 3 |
| 50 | — | — | — | — | — | 25 | 15 | 8 | 4 |
| 60 | — | — | — | — | — | — | 25 | 15 | 5 |

The standard deviations of the measured distances are specified here in centimeters. Since no distance values are determined for intensities that are smaller than the noise floor strength, these entries are empty. In the proposed method, a two-dimensional interpolation can additionally be performed between individual entries of the table as well. This leads to an even further improved accuracy of the averaged distance values.

The entries of the first table used are determined by a preceding calibration measurement. With this calibration measurement, the entire range of combinations of constant light intensities and echo signal intensities of a target is measured. For each combination of noise floor strength, i.e. noise level, and echo intensity, a histogram of the measured distance, i.e. the distance value, is formed and the standard deviation is determined therefrom. The weaker the signal-to-noise ratio, i.e. the higher the noise or the noise floor strength, and the lower the echo intensity, the higher the respective statistical distance error σⱼ.

According to a further development, the second dynamic threshold for the data point is in each case determined in dependence on the statistical error of the distance value of the data point of the first intermediate image or of the individual image and of the statistical error of a respective one of the data points of the settable number of neighboring data points of the first intermediate image or of the individual image in relation to a respective difference of the distance values of the data point of the first intermediate image or of the individual image and of a respective one of the corresponding data points of the settable number of neighboring data points of the first intermediate image or of the individual image. In this respect, the statistical error is in particular the standard deviation and is related to the intensity and the noise floor strength of the respective data point.

The second dynamic threshold is used for the spatial averaging. For the second dynamic threshold, the distance differences of one of the neighboring pixels from the pixel under consideration are in each case used in relation to the standard deviations of the pixel under consideration and the neighboring pixel.

According to a further development, for the spatial averaging, only distance values of the neighboring data points from the first intermediate image or from the individual image are used whose respective difference from the distance value of the data point of the first intermediate image or of the individual image is smaller than a sum of the statistical errors of the distance value of the data point of the first intermediate image or of the individual image and of the respective neighboring data point of the settable number of neighboring data points of the first intermediate image or of the individual image and of an offset value. In this respect, the sum can in particular be a weighted sum. The statistical error is in particular the standard deviation.

The spatial averaging is carried out on the basis of the first intermediate image, which has already been averaged in time, or on the basis of the individual image determined by the sensor. According to the following formula, the data points are determined whose distance values are selected for the spatial averaging:

$${k}_{s} * ( {σ}_{x}^{′} + {σ}_{j}^{′} ) + d \qquad ( 2 )$$

Here, kₛ is a calibratable factor that can be set equal to or different from the above-mentioned factor kₜ and typically lies between one and three. σ′ₓ denotes the standard deviation of the neighboring data point; σ′ⱼ denotes the standard deviation of the data point under consideration. d represents an offset that is constant and that enables the spatial averaging of slanted targets.

If the spatial averaging has already been preceded by the temporal averaging, new statistical distance errors may be calculated for all the data points. In the case of Gaussian-distributed distance distributions, said statistical distance errors are, for example, determined according to the following formula:

$${σ}_{j}^{′} = \frac{\sqrt{{\sum }_{k ∈ F} {σ}_{k}^{2}}}{{N}_{F}} \qquad ( 3 )$$

F denotes the set of time-averaged distance values that resulted in the new distance value of the data point of the first intermediate image. N_{F} denotes the number of distance values of the set F.

For non-Gaussian distance distributions, a formula other than formula (3) can also be used as an approximation.

By using the standard deviation of each distance value of each data point, the blurring of edges is minimized during the spatial averaging. This in particular relates to edges with a medium to very good signal-to-noise ratio. Due to the preceding temporal averaging, the standard deviations are even smaller so that edges are even less distorted. Pixel-to-pixel variations are equalized. The distance offset d from formula (2) is chosen to be small compared to the standard deviations of the distance values.

According to a further development, the statistical error, in particular the standard deviation, of the distance value of the data point of the first intermediate image or of the individual image is selected in each case from a second table that was determined by preceding measurements.

The respective statistical error, in particular the standard deviation, is selected from the second table in relation to the intensity and the noise floor strength of the respective data point. The second table is likewise determined by a preceding measurement, for example analogously to the first table.

In an alternative further development, the statistical error, in particular the standard deviation, of the distance value of the data point of the first intermediate image is in each case selected from the first table that was updated using the first intermediate image.

If a temporal averaging was carried out before the spatial averaging, the first table is updated on the basis of the distance values of the first intermediate image by an averaging with standard deviations according to formula (3) described above.

According to a further development, both the temporal averaging and the spatial averaging are determined on the basis of an arithmetic mean value or a weighted mean value.

For the arithmetic mean value, the quotient is formed from the sum of the distance values of the data points selected for the averaging and from the number of the data points. For this purpose, the following formula can, for example, be used:

$$\overline{{d}_{i}} = \frac{{\sum }_{k ∈ F} {d}_{k}}{{N}_{F}} \qquad ( 4 )$$

Therein, d̅ᵢ̅ in each case denotes the averaged distance value; N_{F} denotes the number of data points used for the averaging.

Instead of using the arithmetic mean value, the distance value of a data point can be weighted according to the signal-to-noise ratio or a standard deviation. As a result, distance values with a small statistical distance error are, for example, weighted higher than distance values with a high statistical distance error. The weighting factors can, for example, be the ratios of the standard deviations of the distance values of the data point currently under consideration to the data point used for the averaging or the quotient of the intensity and the noise floor strength of the same data point. The averaged distance is then calculated using the following formula:

$$\overline{{d}_{i}} = \frac{{\sum }_{k ∈ F} {α}_{k} * {d}_{k}}{{\sum }_{k ∈ F} {α}_{k}} \qquad ( 5 )$$

Here, αₖ denotes the weighting factor in each case.

If a weighted average is used for the temporal averaging, a resulting updated distance standard deviation is calculated using the following formula:

$${σ}_{j}^{′} = \frac{\sqrt{{\sum }_{k ∈ F} {α}_{k}^{2} {σ}_{k}^{2}}}{{\sum }_{k ∈ F} {α}_{k}} \qquad ( 6 )$$

In a further development, the method has the following step after the supply of the individual image and before the determination of the first or the second intermediate image:
sorting out echo signal values of the data point using an existence measure filter.

In the event that more than one echo signal was received for a data point of the individual image, echo signal values that are unsuitable are sorted out again with the help of an existence measure filter. For example, the existence measure filter is set so that a false positive rate of the distance values is low, for example below 1%. Nonsensical distance values are thus sorted out and do not distort the subsequently performed temporal and spatial averaging.

According to a further development, the temporal averaging and/or the spatial averaging is/are each additionally performed in dependence on a third threshold that is intensity-dependent.

The additional third threshold can be referred to as the intensity difference threshold. In detail, in this further development, for the temporal averaging, only distance values of the corresponding data point of preceding individual images are used whose intensity difference from an intensity of the data point of the individual image or of the second intermediate image is smaller than a sum of a statistical error of an intensity of the data point of the individual image or of the second intermediate image and of the corresponding data point of the preceding individual image of the settable number of preceding individual images. In this respect, the sum is in particular a weighted sum. In this respect, the statistical error is in particular the standard deviation of the intensity of the data point. For the spatial averaging, in this further development, only distance values of neighboring data points from the first intermediate image or the individual image are used whose respective intensity difference from the intensity of the data point of the first intermediate image or of the individual image is smaller than a sum of the statistical error of the intensity of the data point of the first intermediate image or of the individual image and of the statistical error of the intensity of the respective neighboring data point of the settable number of neighboring data points of the first intermediate image or the individual image.

In this further development, the third threshold is used in addition to the first or second threshold whose distance criterion is met. For the temporal averaging and the spatial averaging of the distance values, only respective distance values of the identically positioned data point of a preceding individual image or the distance values of respective neighboring data points that each fulfill the above-mentioned are therefore considered in each case. This can be expressed by way of example by the following equation:

$${k}_{i} * ( {σ}_{x}^{int} + {σ}_{i}^{int} ) \qquad ( 7 )$$

Here, kᵢ represents a calibratable factor that is typically between one and three,

$${σ}_{i}^{int}$$

represents the standard deviation of the intensity of the data point to be averaged, and

$${σ}_{x}^{int}$$

represents the standard deviation of the intensity of the neighboring data point in the spatial averaging or the standard deviation of the intensity of a corresponding data point in the preceding individual image in the temporal averaging.

It is thereby ensured that neighboring objects or targets of an individual image that each have a different reflectivity but a small distance difference are not averaged with one another. The distance accuracy is thus improved even further.

The standard deviations as representatives of the statistical error of the intensities can, for example, be taken from a table, similar to the standard deviations of the distance values. Analogously to the above-described procedure for the standard deviations of the distance values, a 2D lookup table is likewise created in a previous calibration measurement for this purpose. Similar to the table above, the respective statistical standard deviations of the measured intensity are entered here in each case in relation to a noise floor strength and an intensity.

In a further development, the determination of the first intermediate image additionally comprises a temporal averaging of the at least one intensity of a plurality of data points, in particular of each data point, of the individual image or of the second intermediate image with a respective intensity of a corresponding data point of a settable number of preceding individual images using the first dynamic threshold. The determination of the second intermediate image then additionally comprises a spatial averaging of the at least one intensity of a plurality of data points, in particular of each data point, of the individual image or of at least one intensity of each data point of the first intermediate image with at least one intensity of a settable number of neighboring data points of the individual image or of the first intermediate image using the first or the second dynamic threshold.

In addition to the optimization of the distance accuracy proposed according to the invention, the intensity of each data point of the frame currently under consideration is improved in this further development by a temporal averaging and spatial averaging. In other words, the intensity image is optimized in its statistical variance. The averaging of the intensity values in this respect takes place in a similar way to the above-described averaging of the distance values in the temporal and spatial range.

In a further development, the temporal averaging and/or the spatial averaging is/are additionally performed in dependence on a fourth threshold that is dependent on the noise floor strength.

In this further development, in addition to the first or the second threshold, whose distance criterion is fulfilled, the fourth threshold is used that can be referred to as the noise floor strength difference threshold. In detail, for the temporal averaging, only distance values of the corresponding data point in one or more preceding individual images are used whose noise floor strength difference from a noise floor strength of the data point of the individual image or of the second intermediate image is smaller than a sum of a statistical error of the noise floor strength of the data point of the individual image or of the second intermediate image and of a statistical error of the noise floor strength of the corresponding data point of the preceding individual image of the settable number of preceding individual images. In this case, for the spatial averaging, only distance values of the neighboring data points from the first intermediate image or from the individual image are used whose respective noise floor strength difference from the noise floor strength of the data point of the first intermediate image or of the individual image is smaller than a sum of the statistical errors of the noise floor strength of the data point of the first intermediate image or of the individual image and of a statistical error of the noise floor strength of the respective neighboring data point of the settable number of neighboring data points of the first intermediate image or of the individual image. In this respect, the sum can also be a weighted sum. A standard deviation of the noise floor strength is a representative of the statistical error of the noise floor strength.

In this embodiment, in addition to the distance difference, the noise floor strength difference in each case between the data point to be averaged and a suitable data point from a preceding frame or from the environment in the current frame is used to restrict the selection of the data points to be averaged in terms of time or space. If the noise floor strengths are also similar, the respective data point is included in the averaging. This is particularly advantageous in scenes with homogeneous lighting, in which different noise floor strengths are necessarily caused by a different reflectivity of the target and not by different environmental light conditions.

In one possible implementation, the statistical errors or statistical fluctuations, in particular the standard deviations, of the noise floor strengths are recorded in a one-dimensional lookup table in dependence on the noise floor strength. An example of such a table has the following form:

| Average noise | | | | | | | |
|---|---|---|---|---|---|---|---|
| floor strength | 0 | 10 | 20 | 30 | 40 | 50 | 60 |
| Standard deviation | 0 | 1 | 3 | 5 | 4 | 3 | 2 |
| of the measured | | | | | | | |
| noise floor | | | | | | | |
| strengths | | | | | | | |

The table therefore assigns the statistical standard deviation of the measured noise floor strength to an averaged noise floor strength. To further increase the accuracy, a one-dimensional interpolation between the individual values is possible. Similarly to the above-described tables, this one-dimensional table is also filled with values from calibration measurements performed in advance.

Therefore, if a noise floor difference between the data point to be averaged and the data point under consideration for this purpose is greater than the sum determined using the following formula, the data point under consideration is not included in the averaging:

$${k}_{n} * ( {σ}_{x}^{r} + {σ}_{i}^{r} ) \qquad ( 8 )$$

Here, kₙ denotes a weighting factor that is typically between one and three,

$${σ}_{i}^{r}$$

denotes the standard deviation of the noise floor strength of the data point to be averaged, and

$${σ}_{x}^{r}$$

denotes the standard deviation of the noise floor strength of the data point under consideration.

The method can, for example, be implemented on a microcontroller or a field programmable gate array (FPGA).

In one embodiment, a time-of-flight sensor comprises a transmission unit, a reception unit and an evaluation unit that are connected to one another. The transmission unit comprises a signal source, in particular a light source, in particular a laser diode, and is configured to transmit a transmission signal, in particular a light beam in pulsed form. The reception unit comprises a receiver element, in particular a light-sensitive element, in particular a photodiode, and is configured to receive the echo signal reflected from a scene. The evaluation unit is configured to generate at least one individual image of a scene, wherein each data point of the individual image comprises a distance value, which is determined from at least one echo signal received by the time-of-flight sensor, an intensity and a noise floor strength. Furthermore, the evaluation unit is configured to determine a first intermediate image by a temporal averaging of the at least one distance value of a plurality of data points, preferably of each data point, of the individual image or of a second intermediate image with a respective distance value of a corresponding data point of a settable number of preceding individual images using a first dynamic threshold that is at least SNR-dependent. The evaluation unit is further configured to determine a second intermediate image by an additional or alternative spatial averaging of the at least one distance value of a plurality of data points, preferably of each data point, of the individual image or by a spatial averaging of at least one distance value of a plurality of data points, preferably of each data point, of the first intermediate image with at least one distance value of a settable number of neighboring data points of the first intermediate image or of the second intermediate image using a second dynamic threshold that is at least SNR-dependent. Finally, the evaluation unit is configured to provide the first or the second intermediate image as the output distance image of the time-of-flight sensor.

The time-of-flight sensor according to the invention processes the originally measured distance image of a scene by a temporal averaging or by a spatial averaging or by a temporal and spatial averaging of the individual data points of this individual image, in each case using dynamic SNR-dependent thresholds, and generates the output distance image therefrom. A distance accuracy of the output distance image is advantageously significantly improved compared to the individual image and compared to a processing according to the prior art that uses fixed distance difference thresholds.

The time-of-flight sensor can be designed as a radar sensor or as a LIDAR sensor. The output distance image is provided with optimized precision by the proposed intelligent temporal and spatial averaging of distance data points.

In another respect, the above statements on the method according to the invention for providing the output distance image apply accordingly to the time-of-flight sensor, in particular with respect to advantages and embodiments.

In one possible implementation, the time-of-flight sensor according to the invention is configured to carry out the above-described method.

A further subject of the invention is a computer program product that comprises a computer-readable storage medium on which a program is stored that enables a computer, after a reading of the program into a memory of the computer, to carry out the above-described method for providing an output distance image of a time-of-flight sensor. This in particular in cooperation with the time-of-flight sensor specified above.

The respective embodiments described here can be combined with one another, unless otherwise explicitly stated or described.

The invention will be explained in more detail in the following purely by way of example with reference to the Figures. There are shown:

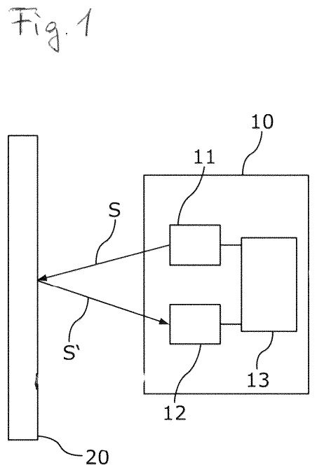

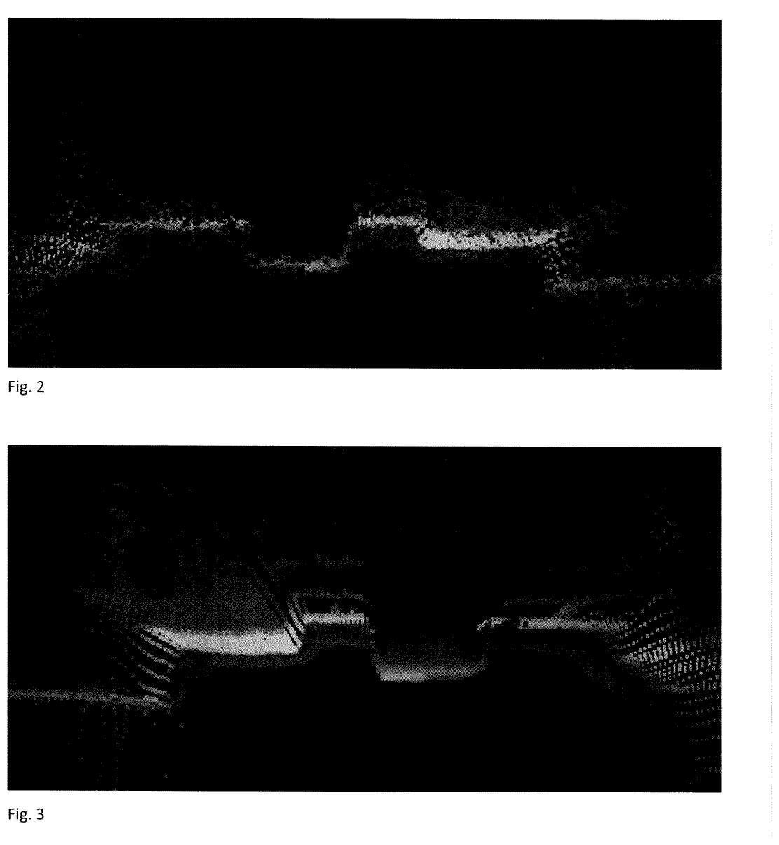

FIG. 1 an exemplary embodiment of a time-of-flight sensor as proposed, FIGS. 2 to 5, in each case, a picture of a scene.

FIG. 1 shows an exemplary embodiment of the time-of-flight sensor as proposed. The time-of-flight sensor 10 is configured as a LIDAR sensor or as a radar sensor. A transmission unit 11 of the sensor 10 generates a transmission signal S, for example with the aid of at least one laser diode. The electromagnetic transmission signal S is reflected at a scene with an exemplary object 20 and is detected by the reception unit 12 of the time-of-flight sensor 10 as an echo signal S′. The evaluation unit 13 of the sensor 10 controls the transmission of the transmission signal S and the reception of the echo signal S′. The evaluation unit 13 is configured to generate an output distance image from the individual image of the scene, which is obtained from the echo signal S′, by an intelligent temporal and spatial averaging of the distance values of the data points of the individual image as explained in more detail above.

FIG. 2 shows an exemplary individual image. It was determined directly from the echo signal and thus shows the respective strongly scattering point cloud of a static, edge-rich example scene.

FIG. 3 shows the so-called ground truth of the scene from FIG. 2 that was achieved by a temporal averaging of 100 frames.

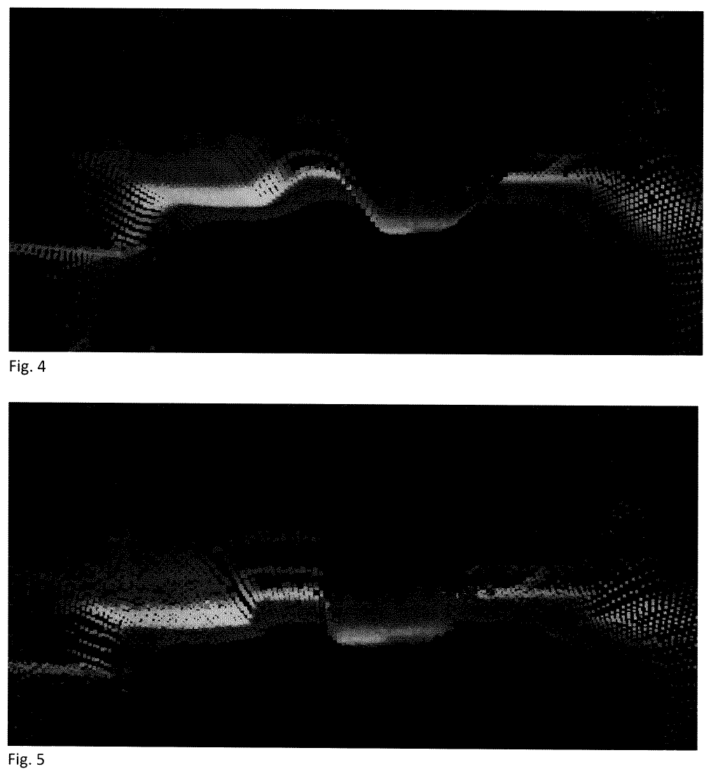

FIG. 4 shows an exemplary output image of a conventional sensor that uses fixed distance thresholds for a temporal averaging and a spatial averaging. In this respect, the temporal averaging took place by way of example via the last five individual images, whereas the spatial averaging related to the 35 neighboring data points in each case.

FIG. 5 shows an exemplary output distance image for the individual image from FIG. 2 that was generated using the method and sensor according to the invention. In this respect, as in FIG. 4, the last five frames were used for the temporal averaging. The 35 neighboring data points were included in the spatial averaging. The increase in the distance accuracy is clearly visible. While FIG. 4 still shows strong distortions due to the spatial averaging using a fixed difference distance threshold, they are no longer present in the output distance image of FIG. 5. Furthermore, the variance of the individual data points is minimal.

### REFERENCE NUMERAL LIST

10 time-of-flight sensor
11 transmission unit
12 reception unit
13 evaluation unit
20 object
S transmission signal
S′ echo signal

1-15. (canceled)

16. A method for providing an output distance image of a time-of-flight sensor comprising the following steps:
supplying an individual image of a scene, wherein each data point of the individual image comprises a distance value, which is determined from at least one echo signal received by the time-of-flight sensor, an intensity and a noise floor strength;
determining a first intermediate image by a temporal averaging of the at least one distance value of a plurality of data points of the individual image or of a second intermediate image with a respective distance value of a corresponding data point of a settable number of preceding individual images using a first dynamic threshold that is at least dependent on the signal-to-noise ratio; and/or
determining a second intermediate image by a spatial averaging of the at least one distance value of the plurality of data points of the individual image or of at least one distance value of a plurality of data points of the first intermediate image with at least one distance value of a settable number of neighboring data points of the individual image or of the first intermediate image using a second dynamic threshold that is at least dependent on the signal-to-noise ratio;
providing the first or the second intermediate image as the output distance image of the time-of-flight sensor.

17. The method according to claim 1,
wherein the first dynamic threshold for the data point is in each case determined in dependence on a statistical error, which is related to the intensity and the noise floor strength of the data point of the distance value of the data point of the individual image or of the second intermediate image and of the corresponding data points of the settable number of preceding individual images in relation to a respective difference of the distance values of the individual image or of the second intermediate image and of the corresponding data points of the settable number of preceding individual images.

18. The method according to claim 1,
wherein, for the temporal averaging, only distance values of the corresponding data point of preceding individual images are used whose difference from the distance value of the data point of the individual image or of the second intermediate image is smaller than a sum of the statistical errors of the distance value of the data point of the individual image or of the second intermediate image and of the corresponding data point of the preceding individual image of the settable number of preceding individual images.

19. The method according to claim 2,
wherein the statistical error of the distance value of the data point of the individual image or of the second intermediate image and of the preceding individual image is in each case selected from a first table that was determined by preceding measurements.

20. The method according to claim 1,
wherein the second dynamic threshold for the data point is in each case determined in dependence on the statistical error, which is related to the intensity and the noise floor strength of the respective data point of the distance value of the data point of the first intermediate image or of the individual image and of a respective one of the corresponding data points of the settable number of neighboring data points of the first intermediate image or of the individual image in relation to a respective difference of the distance values of the data point of the first intermediate image or of the individual image and of a respective one of the data points of the settable number of neighboring data points of the first intermediate image or of the individual image.

21. The method according to claim 1,
wherein, for the spatial averaging, only distance values of the neighboring data points from the first intermediate image or from the individual image are used whose respective difference from the distance value of the data point of the first intermediate image or of the individual image is smaller than a sum of the statistical errors of the distance value of the data point of the first intermediate image or of the individual image and of the respective neighboring data point of the settable number of neighboring data points of the first intermediate image or of the individual image and of an offset value.

22. The method according to claim 5,
wherein the statistical error of the distance value of the data point of the first intermediate image or of the individual image is selected in each case from a second table that was determined by preceding measurements.

23. The method according to claim 5,
wherein the statistical error of the distance value of the data point of the individual image or of the second intermediate image and of the preceding individual image is in each case selected from a first table that was determined by preceding measurements and wherein the statistical error of the distance value of the data point of the first intermediate image is in each case selected from the first table that was updated using the first intermediate image.

24. The method according to claim 1,
wherein both the temporal averaging and the spatial averaging are determined on the basis of an arithmetic mean value or a weighted mean value.

25. The method according to claim 1,
further comprising after the supply of the individual image and before the determination of the first or the second intermediate image:
sorting out echo signal values of the data point using an existence measure filter.

26. The method according to claim 1,
wherein the temporal averaging and/or the spatial averaging is/are additionally performed in dependence on a third threshold that is intensity-dependent.

27. The method according to claim 1,
wherein the determination of the first intermediate image additionally comprises a temporal averaging of the at least one intensity of a plurality of data points of the individual image or of the second intermediate image with a respective intensity of a corresponding data point of a settable number of preceding individual images using the first dynamic threshold, and
wherein the determination of the second intermediate image additionally comprises a spatial averaging of the at least one intensity of a plurality of data points of the individual image or of at least one intensity of each data point of the first intermediate image with at least one intensity of a settable number of neighboring data points of the individual image or of the first intermediate image using the first or the second dynamic threshold.

28. The method according to claim 1,
wherein the temporal averaging and/or the spatial averaging is/are additionally performed in dependence on a fourth threshold that is dependent on the noise floor strength.

29. A time-of-flight sensor comprising
a transmission unit, a reception unit and an evaluation unit that are connected to one another,
wherein the transmission unit comprises a signal source, and is configured to transmit a transmission signal,
wherein the reception unit comprises a receiver element and is configured to receive the echo signal reflected from a scene, and
wherein the evaluation unit is configured
to generate at least one individual image of a scene, wherein each data point of the individual image comprises a distance value, which is determined from at least one echo signal received by the time-of-flight sensor, an intensity and a noise floor strength,
to determine a first intermediate image by a temporal averaging of the at least one distance value of a plurality of data points of the individual image or of a second intermediate image with a respective distance value of a corresponding data point of a settable number of preceding individual images using a first dynamic threshold that is at least dependent on the signal-to-noise ratio, and/or
to determine a second intermediate image by a spatial averaging of the at least one distance value of a plurality of data points of the individual image or of at least one distance value of a plurality of data points of the first intermediate image with at least one distance value of a settable number of neighboring data points of the individual image or of the first intermediate image using a second dynamic threshold that is at least dependent on the signal-to-noise ratio, and
to provide the first or the second intermediate image as the output distance image of the time-of-flight sensor.

30. A computer program product that comprises a computer-readable storage medium on which a program is stored that enables a computer, after a reading of the program into a memory of the computer, to carry out the method according to claim 1.

31. The method according to claim 1, wherein the step of determining the first intermediate image takes place by a temporal averaging of the at least one distance value of data point

32. The method according to claim 1, wherein the step of determining the second intermediate image takes place by a spatial averaging of the at least one distance value of each data point, of the individual image or of at least one distance value of each data point.

33. The method according to claim 3,
wherein the statistical error of the distance value of the data point of the individual image or of the second intermediate image and of the preceding individual image is in each case selected from a first table that was determined by preceding measurements.

34. The method according to claim 6,
wherein the statistical error of the distance value of the data point of the individual image or of the second intermediate image and of the preceding individual image is in each case selected from a first table that was determined by preceding measurements and wherein the statistical error of the distance value of the data point of the first intermediate image is in each case selected from the first table that was updated using the first intermediate image.

35. The time-of-flight sensor according to claim 14, wherein the signal source is a light source.

36. The time-of-flight sensor according to claim 14, wherein the transmission signal is a light beam in pulsed form.

37. The computer program product according to claim 15, that is further configured to carry out said method in cooperation with a time-of-flight sensor, said time-of-flight sensor comprising
a transmission unit, a reception unit and an evaluation unit that are connected to one another,
wherein the transmission unit comprises a signal source, and is configured to transmit a transmission signal,
wherein the reception unit comprises a receiver element and is configured to receive the echo signal reflected from a scene, and
wherein the evaluation unit is configured
to generate at least one individual image of a scene, wherein each data point of the individual image comprises a distance value, which is determined from at least one echo signal received by the time-of-flight sensor, an intensity and a noise floor strength.
